(19) United States
(12) Patent Application Publication
(10) Pub. No.: US 2024/0208750 A1
(43) Pub. Date: Jun. 27, 2024

(54) MEDIUM PROCESSING DEVICE

(71) Applicant: CASIO COMPUTER CO., LTD., Tokyo (JP)

(72) Inventor: Masakazu SUZUKI, Tokyo (JP)

(21) Appl. No.: 18/524,162

(22) Filed: Nov. 30, 2023

(30) Foreign Application Priority Data
Dec. 21, 2022 (JP) 2022-204413

(51) Int. Cl. B65H 3/06; B65H 3/66

(52) U.S. Cl. CPC B65H 3/0661; B65H 3/66; B65H 2553/80

(57) ABSTRACT

A medium processing device includes: a medium conveying mechanism that conveys a sheet-like medium in a medium feeding direction; and a processing unit drive mechanism that includes a support unit that supports a processing unit that processes the medium, the processing unit drive mechanism being capable of executing a first operation of moving the support unit together with the processing unit along the medium in a support unit feeding direction intersecting the medium feeding direction, and a second operation of changing a distance between the medium and the processing unit by rotating the support unit together with the processing unit about a virtual axis along the support unit feeding direction.

### CROSS-REFERENCE TO RELATED APPLICATIONS

The present application is based upon and claims the benefit of priority from Japanese Patent Application No. 2022-204413 filed on Dec. 21, 2022, the entire contents of which are incorporated herein by reference.

### BACKGROUND

### Technical Field

The present invention relates to a medium processing device.

### Related Art

As a processing device that processes a sheet-like medium, a cutting device that performs cutting processing on a medium is known (For example, JP-A 2013-193192, JP-A 2017-100247, and JP-A 2018-167337). The cutting device conveys the medium in a predetermined direction on the basis of the cutting data, and performs control to move the cutting cutter in a direction orthogonal to the conveyance direction of the medium to cut the medium into a predetermined shape (figure, character, or the like).

This type of processing device can perform various types of processing on the medium by selecting the type of tool for processing. For example, by attaching a writing tool instead of a cutter, it can be used as a processing device for drawing.

In the processing device, a tool is configured to approach and move away from a medium, such that the tool approaches the medium in an area where the tool processes the medium (perform cutting, drawing, and the like), and the tool moves away from the medium in an area where the tool does not process the medium. Therefore, it is necessary to cause the tool to perform a tool feeding operation in a direction intersecting the conveyance direction of the medium and a tool contacting and separating operation in a direction changing the distance to the medium.

An aspect of a medium processing device according to the present disclosure includes: a medium conveying mechanism that conveys a sheet-like medium in a medium feeding direction; and a processing unit drive mechanism that includes a support unit that supports a processing unit that processes the medium, the processing unit drive mechanism being capable of executing a first operation of moving the support unit together with the processing unit along the medium in a support unit feeding direction intersecting the medium feeding direction, and a second operation of changing a distance between the medium and the processing unit by rotating the support unit together with the processing unit about a virtual axis along the support unit feeding direction.

### BRIEF DESCRIPTION OF THE DRAWINGS

FIG. 1 is a perspective view of a medium processing device;

FIG. 2 is a perspective view of the medium processing device;

FIG. 3 is a perspective view illustrating a processing unit drive mechanism in the medium processing device;

FIG. 4 is a perspective view illustrating a first gear and a second gear constituting the processing unit drive mechanism;

FIG. 5 is a perspective view of a processing unit holder to which a knife holder is attached;

FIG. 6 is a perspective view of the knife holder;

FIG. 7 is a cross-sectional view of the knife holder;

FIG. 8 is a perspective view of components attached to the knife holder;

FIG. 9 is a cross-sectional view of the medium processing device in a state where a carriage is at the processing position; and

FIG. 10 is a cross-sectional view of the medium processing device in a state where the carriage is at the retraction position.

### DETAILED DESCRIPTION

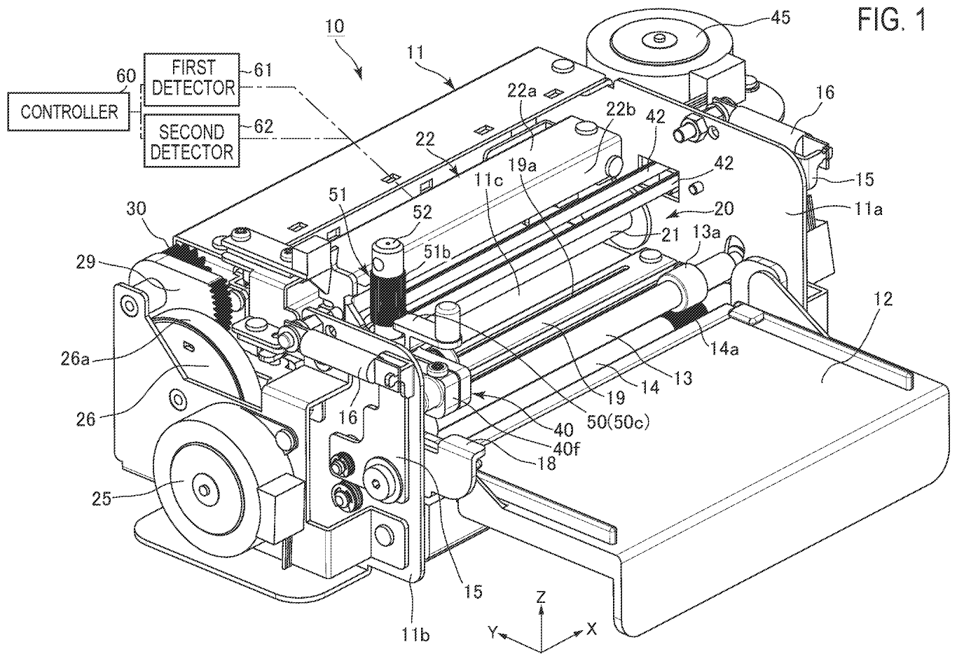

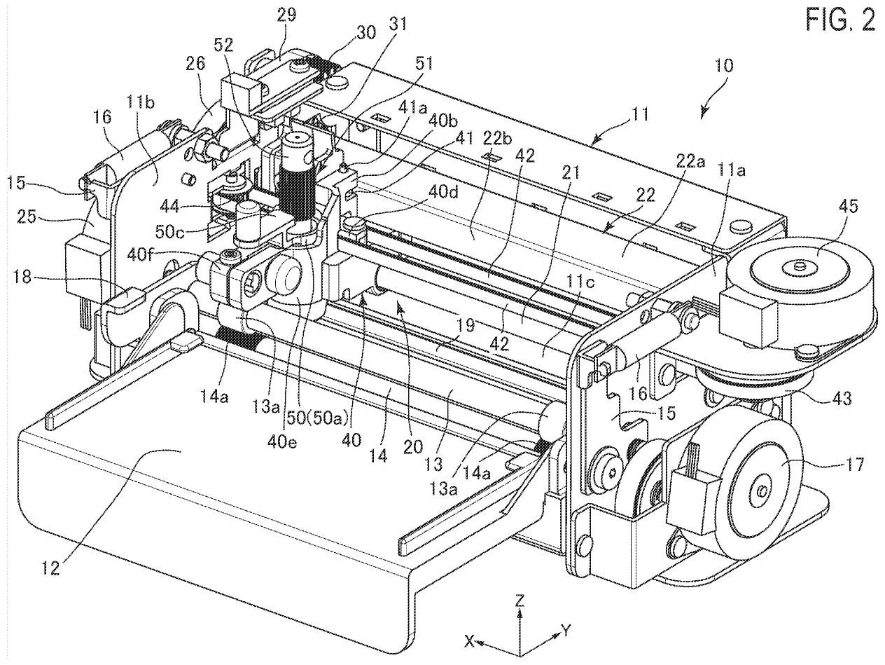

Hereinafter, embodiments of the present invention will be described in detail with reference to the drawings. FIGS. 1 and 2 are perspective views illustrating a medium processing device 10 according to the present embodiment. The X-axis direction (lateral direction, width direction), the Y-axis direction (front-rear direction), and the Z-axis direction (vertical direction) in the medium processing device 10 are directions perpendicular to each other.

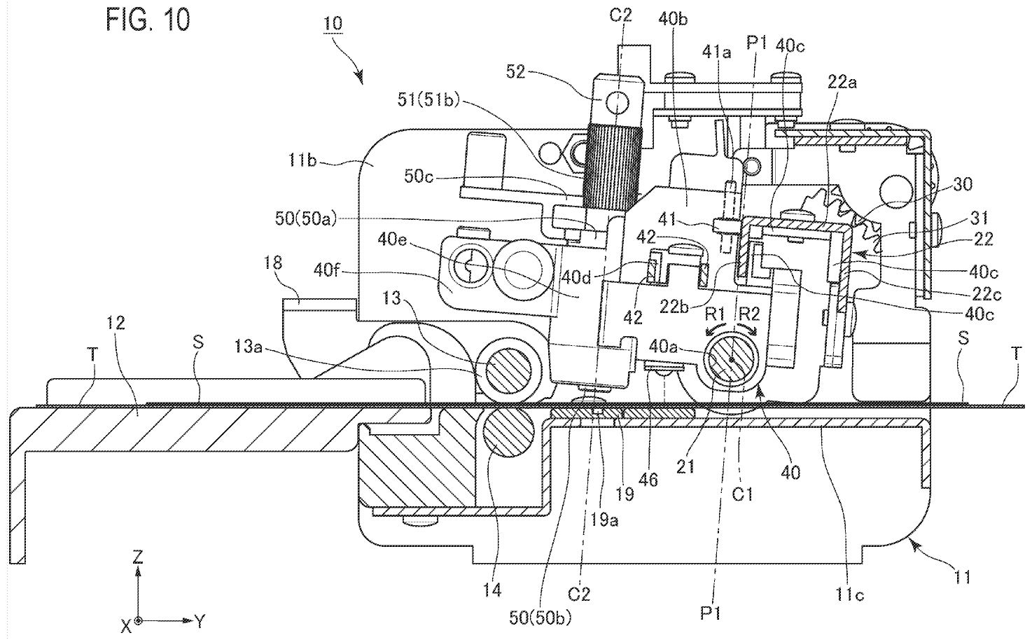

The medium processing device 10 performs processing on the processing target medium S by combining a medium transporting operation of transporting the sheet-like processing target medium S (FIG. 10) in the Y-axis direction, a first operation of moving a processing unit in the X-axis direction along the processing target medium S, and a second operation of changing a distance (interval in the Z-axis direction) between the processing target medium S and the processing unit. The Y-axis direction is a medium feeding direction in which the processing target medium S is conveyed. The X-axis direction is a support unit feeding direction intersecting the medium feeding direction.

The processing target medium S is supplied to the medium processing device 10 in an overlapping manner on a mount T (FIG. 10). Even when the mount T is not mentioned in the following description, the processing target medium S is conveyed or processed in a state of overlapping with the mount T.

A main body 11 of the medium processing device 10 includes a pair of side walls 11a and 11b spaced apart in the X-axis direction, and a lower wall 11c extending in the X-axis direction and connecting the pair of side walls 11a and 11b. The medium processing device 10 may include an exterior member that covers the outside of the main body 11. A tray 12, which is a pedestal on which the processing target medium S is placed, is provided at a front portion of the main body 11 in the Y-axis direction.

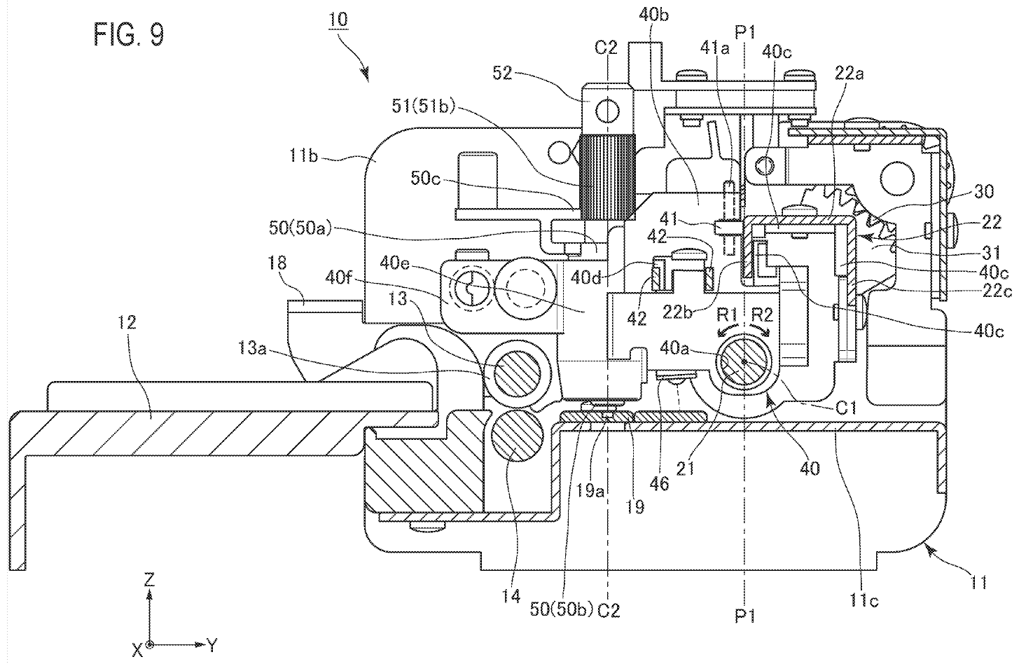

A conveyance roller 13 and a conveyance roller 14 extending in the X-axis direction are supported between the pair of side walls 11a and 11b. As illustrated in FIGS. 9 and 10, the conveyance roller 13 and the conveyance roller 14 are arranged side by side in the Z-axis direction, and are rotatable about a central axis extending in the X-axis direction. The upper conveyance roller 13 is supported by a pair of left and right roller support plates 15 rotatable with respect to the side wall 11a and the side wall 11b, and the distance between the conveyance roller 13 and the conveyance roller 14 in the Z-axis direction changes by the rotation of the pair of roller support plates 15.

In a state where the conveyance roller 13 approaches the conveyance roller 14, the processing target medium S can be sandwiched between the large-diameter nipping portion 13a of the conveyance roller 13 and the large-diameter nipping portion 14a of the conveyance roller 14. A roller biasing spring 16 is connected to each of the pair of roller support plates 15, and the conveyance roller 13 is biased in a direction approaching the conveyance roller 14 (a direction sandwiching the processing target medium S) by a biasing force of the roller biasing spring 16.

The lower conveyance roller 14 is rotated by a driving force generated by a roller drive motor 17 (FIG. 2) attached to a side portion of the side wall 11a. When the conveyance roller 14 is rotated with the processing target medium S sandwiched between the nipping portion 13a and the nipping portion 14a, the processing target medium S is conveyed in the Y-axis direction. The conveyance direction of the processing target medium S in the Y-axis direction can be switched by controlling the roller drive motor 17 to switch the rotation direction of the conveyance roller 14. At least the conveyance roller 13, the conveyance roller 14, and the roller drive motor 17 constitute a medium conveying mechanism that conveys the processing target medium S in the medium feeding direction (Y-axis direction).

A release lever 18 that can be rotated is provided along the side wall 11b. The release lever 18 is connected to one roller support plate 15. When the user operates the release lever 18 to rotate the roller support plate 15, the conveyance roller 13 can be separated from the conveyance roller 14 against the biasing force of the roller biasing spring 16.

A support plate 19 is attached to the upper surface of the lower wall 11c of the main body 11. The support plate 19 is a plate-like member whose longitudinal direction is oriented in the X-axis direction, and a relief groove 19a extending in the X-axis direction is formed on the upper surface side of the support plate 19.

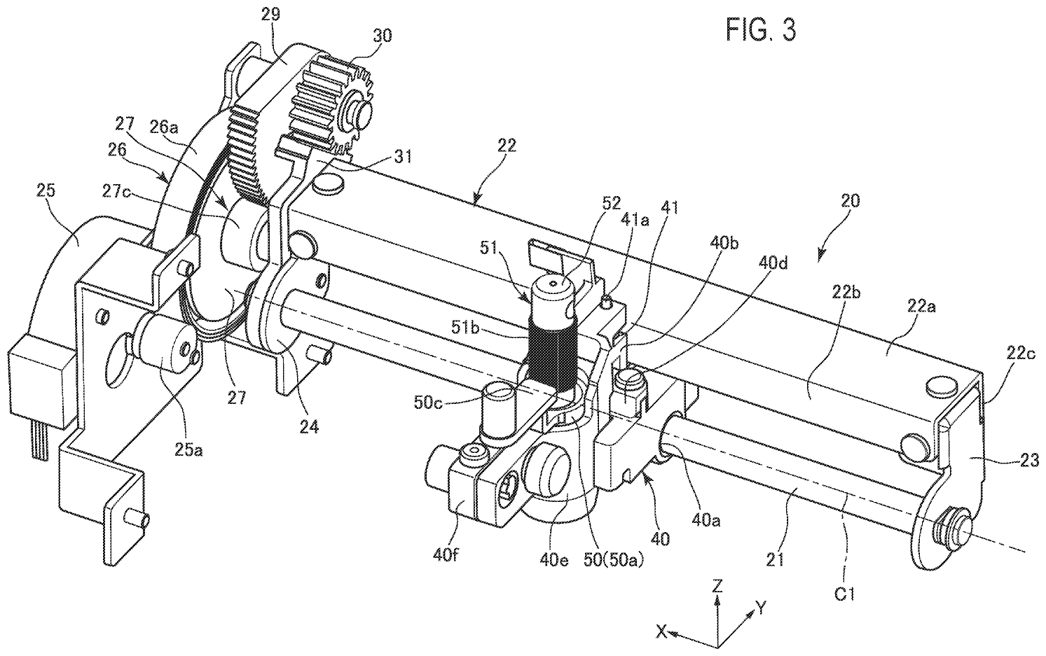

A processing unit drive mechanism 20 illustrated in FIG. 3 can perform a first operation of supporting the processing unit that processes the processing target medium S and moving the processing unit in the X-axis direction (support unit feeding direction) along the processing target medium S and a second operation of changing a distance (interval in the Z-axis direction) between the processing target medium S and the processing unit. Although not illustrated in FIG. 3, the processing unit drive mechanism 20 also includes a drive belt 42, a pulley 43, a pulley 44, a belt drive motor 45, and the like, which will be described later.

The processing unit drive mechanism 20 includes a guide shaft 21 that is a shaft member extending in the X-axis direction, a transmission member 22 that is an elongated member extending in the X-axis direction, and a pair of connection plates 23 and 24 that are connection members connecting vicinities of both ends of the guide shaft 21 and the transmission member 22. The guide shaft 21 has a cylindrical outer peripheral surface, and a virtual axis passing through the center of the guide shaft 21 and extending in the X-axis direction is defined as a central axis C1.

The guide shaft 21 is supported to be rotatable about the central axis C1 with respect to the side wall 11a and the side wall 11b of the main body 11. The side wall 11a and the side wall 11b are each provided with a shaft hole (not illustrated) that rotatably supports the guide shaft 21. The guide shaft 21 and the transmission member 22 are fixed to each other via the connection plate 23 and the connection plate 24. Therefore, the guide shaft 21, the transmission member 22, the connection plate 23, and the connection plate 24 integrally rotate about the central axis C1. In other words, the guide shaft 21 and the transmission member 22 rotate together via the connection plate 23 and the connection plate 24.

An elevation drive motor 25, which is a drive unit for changing the distance between the processing target medium S and the processing unit, is attached to a side portion of the side wall 11b. A pinion 25a is provided on an output shaft of the elevation drive motor 25, and the pinion 25a meshes with a gear portion 26a formed on an outer peripheral surface of a first gear 26.

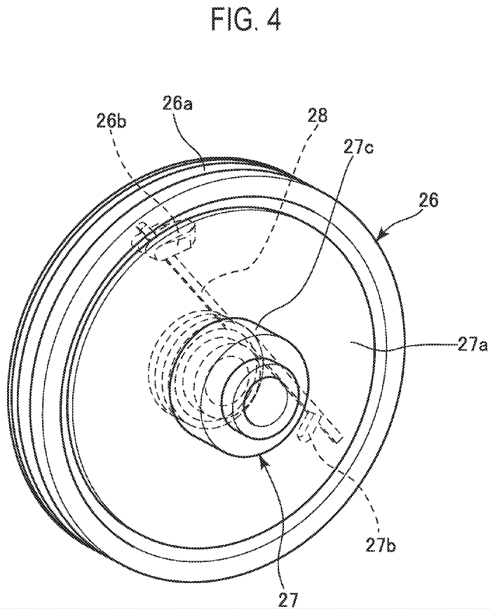

As illustrated in FIG. 4, a transmission portion 27a of a second gear 27 is supported inside the first gear 26. One end and the other end of a torsion spring 28 are engaged with a spring hooking portion 26b provided inside the first gear 26 and a spring hooking portion 27b provided in the transmission portion 27a. When the first gear 26 rotates, the deflection amount of the torsion spring 28 increases, and when the torsion spring 28 reaches a predetermined deflection amount, the rotation is transmitted from the first gear 26 to the second gear 27.

Returning to FIG. 3, the description of the processing unit drive mechanism 20 will be continued. A gear portion 27c of the second gear 27 meshes with a sector gear 29 having a fan shape. A relay gear 30 that rotates integrally coaxially with the sector gear 29 is provided. The relay gear 30 meshes with a sector gear 31 having a fan shape fixed to the connection plate 24. The rotation of the second gear 27 is transmitted to the sector gear 29, and the relay gear 30 rotates together with the sector gear 29. The rotation of the relay gear 30 is transmitted to the sector gear 31. When the sector gear 31 rotates, the guide shaft 21, the transmission member 22, the connection plate 23, and the connection plate 24 integrally rotate about the central axis C1.

When the elevation drive motor 25 is driven in this manner, the force is transmitted by the gears 26, 27, 29, 30, and 31, and the guide shaft 21, the transmission member 22, the connection plate 23, and the connection plate 24 rotate about the central axis C1. By controlling the elevation drive motor 25 to switch the rotation direction of the pinion 25a, the rotation direction of the guide shaft 21, the transmission member 22, the connection plate 23, and the connection plate 24 can be switched between a first direction R1 and a second direction R2 (FIGS. 9 and 10).

Each of the first gear 26, the second gear 27, the sector gear 29, and the relay gear 30 is supported by the side wall 11b so as to be rotatable about a gear axis extending in the X-axis direction. A pressing load of a knife 56 to be described later on the processing target medium S is changed by the torsion spring 28 provided between the first gear 26 and the second gear 27.

A carriage 40 is supported via the guide shaft 21 and the transmission member 22. The carriage 40 is a support unit that supports the processing unit.

The carriage 40 has a shaft insertion hole 40a penetrating in the X-axis direction, and the guide shaft 21 is inserted into the shaft insertion hole 40a. The shaft insertion hole 40a has a cylindrical inner peripheral surface, and the inner peripheral surface of the shaft insertion hole 40a comes into sliding contact with the outer peripheral surface of the guide shaft 21, whereby the carriage 40 is movably supported in the X-axis direction. The carriage 40 is supported so as to be rotatable about the central axis C1 by the guide shaft 21 being passed through the shaft insertion hole 40a. The movement of the carriage 40 in the X-axis direction is defined as a first operation, and the rotation of the carriage 40 about the central axis C1 is defined as a second operation.

The transmission member 22 is a U-shaped cross-sectional member having an upper surface portion 22a, a front surface portion 22b, and a rear surface portion 22c, each of which is a planar wall portion. The front surface portion 22b extends downward from a front edge of the upper surface portion 22a, and the rear surface portion 22c extends downward from a rear edge of the upper surface portion 22a.

As illustrated in FIGS. 9 and 10, the front surface portion 22b of the transmission member 22 is a planar portion located on a virtual plane P1 including the central axis C1 of the guide shaft 21. The rear surface portion 22c is a parallel planar portion substantially parallel to the front surface portion 22b. The upper surface portion 22a is a connection planar portion that connects upper ends of the front surface portion 22b and the rear surface portion 22c.

As illustrated in FIGS. 9 and 10, the carriage 40 includes a main body 40b and a fitting portion 40c that is located at a rear portion of the main body 40b. The shaft insertion hole 40a is formed in a rear lower portion of the main body 40b. The fitting portion 40c enters the inside of the U-shaped transmission member 22 and is in contact with the inner surfaces of the upper surface portion 22a, the front surface portion 22b, and the rear surface portion 22c, and movement in the Y-axis direction and the Z-axis direction with respect to the transmission member 22 is restricted. The fitting portion 40c can move in the X axis direction with respect to the transmission member 22.

The carriage 40 is provided with a bearing 41. The bearing 41 is rotatably supported via a support shaft 41a provided in the main body 40b, and has a cylindrical outer peripheral surface centered on the support shaft 41a. The support shaft 41a is substantially perpendicular to the X-axis direction and extends substantially parallel to the front surface portion 22b of the transmission member 22.

The bearing 41 is a contact portion that comes into contact with the front surface portion 22b of the transmission member 22. The bearing 41 is disposed on the rear surface side of the main body 40b, and the outer peripheral surface of the bearing 41 is in contact with the front surface portion 22b of the transmission member 22. More specifically, the bearing 41 is in contact with a position close to the upper end of the front surface portion 22b, that is, in the vicinity of a corner portion of the front surface portion 22b connected to the upper surface portion 22a.

The carriage 40 can move (first operation) in the X axis direction with respect to the transmission member 22 while rotating or sliding the bearing 41 in contact with the front surface portion 22b. In the second operation that is the rotation about the central axis C1, the bearing 41 is pressed by the front surface portion 22b of the transmission member 22, the carriage 40 rotates in the first direction R1, and the fitting portion 40c receives a force from the transmission member 22, so that the carriage 40 rotates in the second direction R2.

The main body 40b of the carriage 40 is provided with a belt connection portion 40d. The drive belt 42 is connected to the belt connection portion 40d. As illustrated in FIG. 2, the drive belt 42 is an endless belt bridged between the pulley 43 supported on the side wall 11a side and the pulley 44 supported on the side wall 11b side, and has a loop structure in which the drive belt 42 turns between the pulley 43 and the pulley 44.

The pulley 43 is rotated by the driving force generated by the belt drive motor 45 attached to the side portion of the side wall 11a. When the pulley 43 is rotated by the driving of the belt drive motor 45, the drive belt 42 moves in the X-axis direction to transmit the force to the belt connection portion 40d, thereby moving the carriage 40 in the X-axis direction. The moving direction of the carriage 40 in the X-axis direction can be switched by controlling the belt drive motor 45 to switch the rotation direction of the pulley 43.

As described above, in the processing unit drive mechanism 20, the carriage 40 can be caused to rotate about the central axis C1 by the driving of the elevation drive motor 25. The carriage 40 can be moved in the X axis direction by driving the belt drive motor 45.

The carriage 40 includes a holder detachable portion 40e at a front portion of the main body 40b. The holder detachable portion 40e has a tubular shape extending vertically, and a processing unit holder 50 can be attached to and detached from the holder detachable portion 40e. A clamp portion 40f having a bifurcated shape whose interval is adjustable in the X-axis direction is provided on a side surface of the holder detachable portion 40e. By tightening the clamp portion 40f, the processing unit holder 50 inserted into the holder detachable portion 40e is fixed.

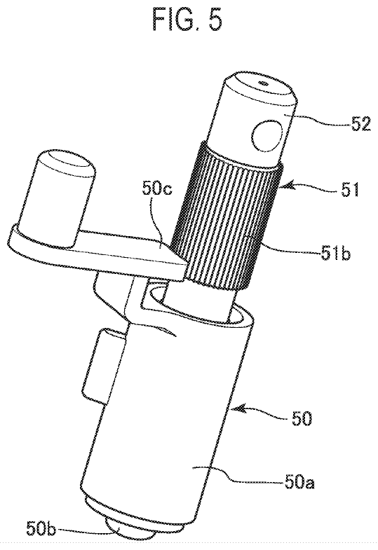

As illustrated in FIG. 5, the processing unit holder 50 includes a holding tubular portion 50a that is a cylindrical shape and extending vertically. An annular protruding portion 50b is formed at the lower end of the holding tubular portion 50a. The holding tubular portion 50a has a through hole communicating from the upper end to the annular protruding portion 50b on the lower end side, and a female screw portion (not illustrated) is formed in a part of the inner peripheral surface of the through hole.

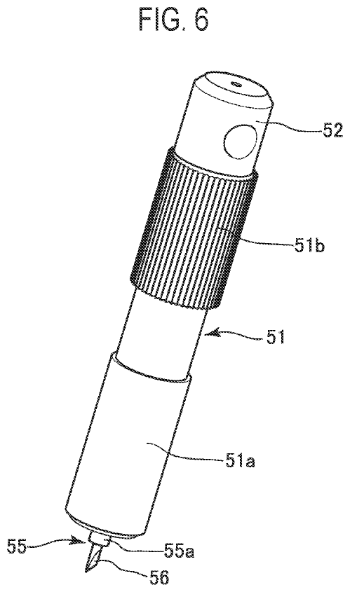

Various processing units for processing the processing target medium S can be attached to the processing unit holder 50. The present embodiment illustrates a case where the knife 56 (see FIGS. 6 to 8) which is a cutting tool is applied as the processing unit. The knife 56 is attached to the processing unit holder 50 via a knife holder 51.

As illustrated in FIG. 6, the knife holder 51 has a columnar schematic shape that can be inserted into the holding tubular portion 50a of the processing unit holder 50. A male screw portion 51a screwed into the female screw portion of the holding tubular portion 50a is provided on an outer peripheral surface of a lower part of the knife holder 51 that can be inserted into the holding tubular portion 50a. A knurled portion 51b is formed on an outer peripheral surface of the knife holder 51 above the male screw portion 51a. When a user grips the portion of the knurled portion 51b and rotationally operates the knife holder 51, the male screw portion 51a is screwed into or unscrewed from the female screw portion of the holding tubular portion 50a, and the knife holder 51 can be attached to or detached from the processing unit holder 50.

The processing unit holder 50 includes a fitting portion 50c protruding upward from the holding tubular portion 50a. In a state where the knife holder 51 is attached to the processing unit holder 50, the fitting portion 50c is lightly fitted to the knurled portion 51b, so that the knife holder 51 can be stably held. In this state, the knife holder 51 can be rotated with respect to the processing unit holder 50 with a click feeling.

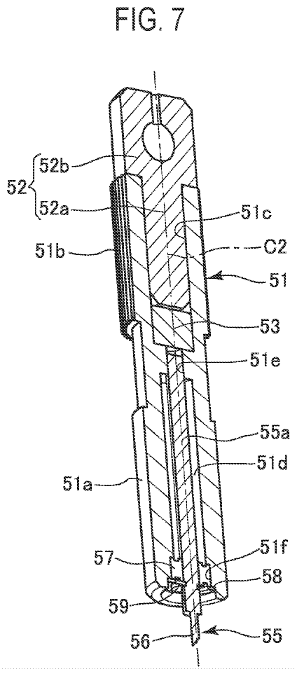

As illustrated in FIG. 7, an upper accommodating portion 51c and a lower accommodating portion 51d each having a cylindrical inner peripheral surface are provided inside the knife holder 51. A small-diameter hole portion 51e having an inner diameter smaller than those of the upper accommodating portion 51c and the lower accommodating portion 51d is formed between the upper accommodating portion 51c and the lower accommodating portion 51d. A large-diameter hole 51f having an inner diameter larger than that of the lower accommodating portion 51d is formed at a lower end of the lower accommodating portion 51d.

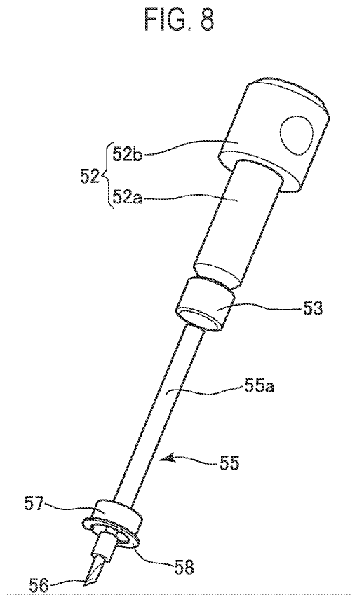

A cap 52 and a magnet 53 are inserted into the upper accommodating portion 51c of the knife holder 51. The magnet 53 is first inserted into the upper accommodating portion 51c from above, and the magnet 53 is supported at the bottom portion (boundary portion with the small-diameter hole portion 51e) of the upper accommodating portion 51c. As shown in FIGS. 7 and 8, the cap 52 includes an insertion portion 52a inserted into the upper accommodating portion 51c, and a large-diameter portion 52b having a larger-diameter than the insertion portion 52a and protruding to the upper portion of the knife holder 51. The insertion portion 52a is held inside the upper accommodating portion 51c by means such as light press fitting, and restricts detachment of the magnet 53 from the upper accommodating portion 51c. The insertion portion 52a can be inserted into the upper accommodating portion 51c or the insertion portion 52a can be pulled out from the upper accommodating portion 51c while holding the large-diameter portion 52b.

The knife unit 55 is inserted into the lower accommodating portion 51d of the knife holder 51 from below. As illustrated in FIGS. 7 and 8, the knife unit 55 has a shaft portion 55a having a rod-like shape, and the knife 56 as a cutting tool is fixed to a lower end of the shaft portion 55a.

A knife bearing 57 having an annular shape is attached inside the large-diameter hole 51f of the knife holder 51. The knife bearing 57 is restricted from being detached downward from the large-diameter hole 51f by a snap ring 58. The shaft portion 55a of the knife unit 55 is supported via the knife bearing 57 so as to be rotatable about the central axis C2 of the knife holder 51. Further, a snap ring 59 fitted to the knife unit 55 abuts on the lower surface of the knife bearing 57, and the maximum insertion amount of the shaft portion 55a into the inside (upward) of the lower accommodating portion 51d is determined.

As illustrated in FIG. 7, the upper end of the shaft portion 55a is inserted into the small-diameter hole portion 51e, and is located in the vicinity of the magnet 53 installed inside the upper accommodating portion 51c. The knife unit 55 (at least the shaft portion 55a) is made of a magnetic material, is attracted upward by the magnetic force of the magnet 53, and a state in which the knife unit 55 is inserted into the lower accommodating portion 51d is maintained. When the cap 52 and the magnet 53 are removed from the knife holder 51, the holding by the magnetic force of the magnet 53 is released, and the knife unit 55 can be pulled out below the knife holder 51.

As illustrated in FIG. 7, with the cap 52, the magnet 53, and the knife unit 55 attached to the knife holder 51, the knife 56 protrudes downward from the lower end of the knife holder 51. When the knife holder 51 in this state is attached to the processing unit holder 50, the screwing amount of the male screw portion 51a with respect to the female screw portion of the holding tubular portion 50a is adjusted such that the tip end of the knife 56 protrudes slightly downward from the lower end surface of the annular protruding portion 50b of the processing unit holder 50. More specifically, the amount of protrusion of the cutting edge of the knife 56 is set such that at least the knife 56 penetrates the thickness of the processing target medium S in a state where the carriage 40 is at a processing position described later.

In a state where the knife holder 51 is attached to the processing unit holder 50 and the processing unit holder 50 is attached to the carriage 40, the knife 56 is positioned above the relief groove 19a of the support plate 19.

As illustrated in FIGS. 9 and 10, a position detection sensor 46 is provided on the lower surface of the carriage 40. The position detection sensor 46 is a non-contact sensor that optically detects an alignment mark (registration mark) provided on the processing target medium S. The position detection sensor 46 is positioned between the shaft insertion hole 40a and the holder detachable portion 40e in the Y-axis direction.

The medium processing device 10 includes a controller 60 (see FIG. 1). The controller 60 includes a processor such as a central processing unit (CPU) and a storage unit, and controls the operation of each unit of the medium processing device 10 by reading a program stored in the storage unit and executing the program by the processor. The controller 60 controls at least operations of the roller drive motor 17, the elevation drive motor 25, and the belt drive motor 45.

The medium processing device 10 includes a first detector 61 and a second detector 62 both configured to detect two rotation positions of the transmission member 22 and the carriage 40 about the guide shaft 21 (see FIG. 1). For example, each of the first detector 61 and the second detector 62 includes an optical sensor such as a photointerrupter, and detection is performed at the moment when a part of the transmission member 22 passes between the light projection unit and the light reception unit of the photointerrupter and light is blocked.

The first detector 61 detects the processing positions (FIG. 9) of the transmission member 22 and the carriage 40. The processing position is a height position at which the knife 56 supported via the carriage 40, the processing unit holder 50, and the knife holder 51 approaches and cuts (processes) the processing target medium S attached to the medium processing device 10. At the processing position, the upper surface portion 22a of the transmission member 22 is substantially horizontal (substantially perpendicular to the Z-axis direction), the front surface portion 22b and the rear surface portion 22c are substantially perpendicular (substantially perpendicular to the Y-axis direction), and the central axis C2 of the knife holder 51 faces the Z-axis direction.

The second detector 62 detects the retraction position (FIG. 10) of the transmission member 22 and the carriage 40. The retraction position is a height position at which the knife 56 supported via the carriage 40, the processing unit holder 50, and the knife holder 51 retracts upward from the processing target medium S without cutting the processing target medium S attached to the medium processing device 10. In the retraction position, the transmission member 22 is inclined so as to lower the rear surface portion 22c side downward, and along with the inclination of the transmission member 22, the processing unit holder 50 and the knife holder 51 positioned forward of the guide shaft 21 in the Y-axis direction are inclined so as to increase the distance from the processing target medium S in the Z-axis direction.

By rotating the guide shaft 21, the transmission member 22, the connection plate 23, and the connection plate 24 in the first direction R1, the transmission member 22 and the carriage 40 move toward the processing position. By rotating the guide shaft 21, the transmission member 22, the connection plate 23, and the connection plate 24 in the second direction R2, the transmission member 22 and the carriage 40 move toward the retraction position.

Detection signals of the position detection sensor 46, the first detector 61, and the second detector 62 are input to the controller 60.

The operation of the medium processing device 10 having the above configuration will be described. When attaching the processing target medium S to the medium processing device 10, the user operates the release lever 18 to separate the conveyance roller 13 upward from the conveyance roller 14. Further, the controller 60 controls the elevation drive motor 25 to position the transmission member 22 and the carriage 40 at the retraction position (FIG. 10).

Subsequently, the processing target medium S is placed on the tray 12, and the processing target medium S is inserted between the conveyance roller 13 and the conveyance roller 14. The user operates the release lever 18 to bring the conveyance roller 13 close to the conveyance roller 14 and hold the processing target medium S between the nipping portion 13a and the nipping portion 14a.

The controller 60 drives the roller drive motor 17 to feed the processing target medium S in the Y-axis direction, drives the belt drive motor 45 to adjust the position of the carriage 40 in the X-axis direction, and detects the alignment mark of the processing target medium S by the position detection sensor 46. The processing target medium S is supported below the carriage 40 while being placed on the upper surface of the support plate 19. In this state, preparation for cutting processing on the processing target medium S by the medium processing device 10 is completed.

When detecting the alignment mark of the processing target medium S using the position detection sensor 46, the controller 60 may drive the elevation drive motor 25 to rotate the transmission member 22 and the carriage 40 between the retraction position and the processing position, and adjust the focal position of the position detection sensor 46 at which optimum detection accuracy can be obtained. Since the position detection sensor 46 is provided in the carriage 40, the distance of the position detection sensor 46 with respect to the processing target medium S changes with the rotation of the carriage 40, so that such adjustment can be performed.

The detection of the alignment mark of the processing target medium S using the position detection sensor 46 is not limited to the preparation stage of the cutting processing, and can be appropriately performed even during the progress of the cutting processing.

Cutting data for cutting the processing target medium S is input to the controller 60, and cutting processing is executed on the basis of the cutting data. By driving the belt drive motor 45 to move the carriage 40 in the X-axis direction and driving the roller drive motor 17 to move the processing target medium S in the Y-axis direction, the processing target medium S and the knife 56 can be relatively moved along the trajectory along the cutting line.

Then, in the cutting target area, the controller 60 drives the elevation drive motor 25 to rotate the transmission member 22 and the carriage 40 in the first direction R1 to move from the retraction position to the processing position. As a result, the knife 56 descends and approaches the processing target medium S, and the knife 56 is cut into the processing target medium S to execute cutting. The relief groove 19a of the support plate 19 is provided below the knife 56. Then, when the knife 56 cut into the processing target medium S passes through the mount T below the processing target medium S, the cutting edge of the knife 56 enters the inside of the relief groove 19a, so that the knife 56 can be prevented from interfering with surrounding members.

The forming range of the sector gear 29 is set such that the meshing of the second gear 27 with the gear portion 27c is released when the force for turning the transmission member 22 and the carriage 40 in the first direction R1 is further received from the elevation drive motor 25 in the state where the transmission member 22 and the carriage 40 reach the processing position. Therefore, the carriage 40 is not excessively rotated in the first direction R1 beyond the processing position (the holder detachable portion 40e supporting the knife 56 is not excessively lowered in the Z-axis direction), and it is possible to prevent an overload from being applied to the processing unit drive mechanism 20.

The knife unit 55 including the knife 56 is supported so as to be rotatable about the central axis C2 with respect to the knife holder 51. Therefore, the direction of the knife 56 cut into the processing target medium S is changed by frictional force or the like acting between the knife 56 and the processing target medium S such that the direction of the cutting edge always follows the advancing direction of cutting, and cutting can be executed smoothly.

In particular, since the knife unit 55 is attracted by the magnetic force of the magnet 53 and the knife unit 55 is supported by the knife holder 51 via the knife bearing 57, the rotational resistance with respect to the knife unit 55 is extremely small, and the followability of the knife 56 with respect to the change in the progressing direction of cutting is excellent.

In the area not targeted for cutting, the controller 60 drives the elevation drive motor 25 to rotate the transmission member 22 and the carriage 40 in the second direction R2 to move from the processing position to the retraction position. As a result, the knife 56 is raised and separated from the processing target medium S, and the knife 56 is not cut into the processing target medium S.

When the series of cutting operations based on the cutting data is completed, the controller 60 drives the elevation drive motor 25 to rotate the transmission member 22 and the carriage 40 in the second direction R2 and hold them at the retraction position. The user operates the release lever 18 to separate the conveyance roller 13 from the conveyance roller 14, and releases the nipping of the processing target medium S by the nipping portion 13a and the nipping portion 14a.

As described above, in the processing unit drive mechanism 20 of the medium processing device 10, the first operation of moving the carriage 40 together with the knife 56 in the support unit feeding direction (X-axis direction) and the second operation of changing the distance between the processing target medium S and the knife 56 by rotating the carriage 40 together with the knife 56 about the virtual axis (central axis C1) along the support unit feeding direction (X-axis direction) can be executed. Therefore, the processing unit drive mechanism 20 for operating the knife 56 in a plurality of directions can have a simple structure with a small number of guide shafts. In addition, since the structure of the processing unit drive mechanism 20 is simple, the accuracy error accumulated in each unit of the mechanism is small, and the operation of the knife 56 can be performed with high accuracy.

For example, unlike the present embodiment, in a structure including a first stage that moves only in the X-axis direction and a second stage that moves only in the Z-axis direction with respect to the first stage, and in which the processing unit is supported by the second stage, the first stage includes a guide unit (guide shaft or the like) extending in the Z-axis direction, and the second stage is slidably attached to the guide unit. In this case, the number of movable stages is large, and the structure becomes complicated. In addition to the accuracy error in the portion that movably supports the first stage, the accuracy error in the portion that movably supports the second stage with respect to the first stage (the portion of the guide unit extending in the Z-axis direction) accumulates, and thus, it is difficult to manage the position accuracy of the processing unit. In particular, in order to smoothly move the second stage, it is necessary to secure a predetermined clearance also between the guide unit extending in the Z-axis direction and the second stage, and the position of the second stage in the X-axis direction and the Y-axis direction is easily displaced.

In contrast, in the medium processing device 10 of the present embodiment, both the movement of the knife 56 in the X-axis direction and the movement of the knife 56 in the direction of approaching and separating from the processing target medium S (direction approximate to the Z-axis direction) are performed as the operation of the carriage 40, and thus the number of parts is small and the structure is simple as compared with the configuration in which these movements are performed via multi-stage stages.

In addition, since the processing unit holder 50 and the knife holder 51 are fixed to and integrated with the carriage 40, positional displacement of the processing unit holder 50 and the knife holder 51 with respect to the carriage 40 is unlikely to occur.

The force rotating about the central axis C1 of the guide shaft 21 is transmitted from the transmission member 22 to the carriage 40. The transmission member 22 and the carriage 40 are in contact with each other at a position separated from the central axis C1 in the radial direction of the guide shaft 21, and can easily stabilize the posture of the carriage 40 in the rotation direction around the central axis C1 and can efficiently transmit the rotation force from the transmission member 22 to the carriage 40.

In addition, since the rotation is transmitted to the carriage 40 via the transmission member 22, the shaft insertion hole 40a and the guide shaft 21 of the carriage 40 can be configured as a simple cylindrical surface having no complicated shape for rotation transmission.

The transmission member 22 having a U-shaped cross section including the upper surface portion 22a, the front surface portion 22b, and the rear surface portion 22c has high rigidity while being a long member long in the X-axis direction. Further, both ends of the guide shaft 21 and the transmission member 22 are fixed by the pair of connection plates 23 and 24, and a combination of the guide shaft 21, the transmission member 22, the connection plate 23, and the connection plate 24 provides very high rigidity. As a result, when the elevation drive motor 25 is driven, twisting of the guide shaft 21 and the transmission member 22 is suppressed, and the carriage 40 can be stably rotated while being supported with high accuracy.

The carriage 40 is required to move smoothly when the belt drive motor 45 is driven to move in the X-axis direction, and to reliably rotate together with the transmission member 22 when the elevation drive motor 25 is driven to rotate.

In the carriage 40, while the shaft insertion hole 40a is supported by the guide shaft 21, the bearing 41 comes into contact with the front surface portion 22b of the transmission member 22 to receive the guide, and thus inclination and rattling with respect to the guide shaft 21 and the transmission member 22 are suppressed, and the carriage can smoothly move in the X-axis direction.

In addition, since the bearing 41 comes into contact with the front surface portion 22b of the transmission member 22 and the fitting portion 40c comes into contact with the inside of the transmission member 22, the force in the rotation direction about the guide shaft 21 is reliably transmitted from the transmission member 22 to the carriage 40.

In particular, the front surface portion 22b of the transmission member 22 with which the bearing 41 is in contact is located on a virtual plane P1 including the central axis C1 of the guide shaft 21. That is, the front surface portion 22b is configured as a planar portion extending from the central axis C1 in the radial direction of the guide shaft 21. As a result, when the transmission member 22 rotates in the first direction R1, the front surface portion 22b always abuts on the bearing 41 as a surface substantially perpendicular to the traveling direction of the rotation to press the bearing 41. As a result, when the transmission member 22 rotates, the force is efficiently transmitted from the front surface portion 22b to the bearing 41 (pressing the bearing 41) without generating an extra component force, and the carriage 40 can be stably moved to the processing position.

The bearing 41 is in contact with the vicinity of a corner portion of the front surface portion 22b connected to the upper surface portion 22a. The portion of the transmission member 22 has high accuracy and rigidity, and the contact between the front surface portion 22b and the bearing 41 can be managed with high accuracy to stably move the carriage 40 to the processing position.

Therefore, when the knife 56 is lowered to cut the processing target medium S, the force of cutting by the knife 56 (the force of pushing the carriage 40) is stabilized, and highly accurate processing can be achieved.

As described above, the medium processing device 10 of the present embodiment can simplify the structure of the processing unit drive mechanism 20 that supports and operates the knife 56, which is a processing unit, and can stably operate the knife 56 with high accuracy.

The type of processing performed on the processing target medium S is not limited to cutting by the knife 56. For example, the knife holder 51 can be removed from the processing unit holder 50, and instead, the writing tool can be attached to the processing unit holder 50 to perform drawing processing using the writing tool on the processing target medium S. Further, it is also possible to select a processing unit other than the knife or the writing tool and perform processing other than cutting and drawing on the processing target medium S.

It is also possible to adopt a configuration in which the processing unit holder 50 is removed from the holder detachable portion 40e of the carriage 40, and a processing unit such as a writing tool is directly attached to the holder detachable portion 40e.

The above embodiments have been given as specific examples to facilitate understanding of the invention, and the present invention is not limited to these embodiments, and various modifications and changes can be made without departing from the gist of the invention.

In the medium processing device 10 of the above-described embodiment, in the processing unit drive mechanism 20, the carriage 40 is moved in the X-axis direction (support unit feeding direction) along the guide shaft 21 to execute the first operation, and the carriage 40 is rotated about the central axis C1 passing through the center of the guide shaft 21 to execute the second operation. That is, the virtual axis (central axis C1), which is the center of the rotation of the support unit (carriage 40) in the second operation, passes through the center of the member (guide shaft 21) that guides the support unit (carriage 40) in the support unit feeding direction in the first operation. However, as means for movably guiding the support unit in the support unit feeding direction, it is also possible to apply a configuration other than the shaft member such as the guide shaft 21.

For example, as a modified example, a guide rail extending in the support unit feeding direction may be provided on a planar portion corresponding to the front surface portion 22b of the transmission member 22, and the support unit (member corresponding to the carriage 40 of the above embodiment) may be movably guided in the support unit feeding direction via the guide rail. In this case, the guide shaft 21 of the above embodiment may not be provided, and the transmission member 22 may be configured to be rotatably supported directly (not via the guide shaft 21) with respect to the side wall 11a and the side wall 11b of the main body 11.

Even in such a modified example, the second operation of changing the distance between the medium (the processing target medium S) and the processing unit (such as the knife 56) can be performed by rotating the support unit about a virtual axis along the support unit feeding direction. In other words, the portion that guides the support unit so as to be movable in the support unit feeding direction in the first operation and the virtual axis that is the center of the second operation of the support unit may be provided at different positions.

In the medium processing device 10 of the above embodiment, the support unit feeding direction (X-axis direction) is set substantially perpendicular to the medium feeding direction (Y-axis direction) in which the processing target medium S is conveyed, but the present invention can also be applied to a configuration in which the supporting unit feeding direction is not perpendicular to the medium feeding direction. That is, the support unit feeding direction may be at least a direction intersecting the medium feeding direction.

In the medium processing device 10 of the above embodiment, the outer peripheral surface of the guide shaft 21 and the inner peripheral surface of the shaft insertion hole 40a of the carriage 40 each have a cylindrical shape (circular cross-sectional shape), and the force rotating in the first direction RI or the second direction R2 is not transmitted between the guide shaft 21 and the carriage 40. However, the outer peripheral surface of the guide shaft 21 and the inner peripheral surface of the shaft insertion hole 40a of the carriage 40 may each have a non-cylindrical shape (non-circular cross-sectional shape), and a force rotating in the first direction R1 or the second direction R2 may be transmitted between the guide shaft 21 and the carriage 40.

In the medium processing device 10 of the above embodiment, the guide shaft 21 and the transmission member 22 are fixed to each other via the pair of connection plates 23 and 24, and have high rigidity. However, instead of the guide shaft 21, a guide shaft fixed (not rotated) to the side wall 11a and the side wall 11b of the main body 11 may be provided, and the pair of connection plates 23 and 24 may be rotatably supported with respect to the fixed guide shaft. That is, the shaft member (guide shaft) that guides the carriage 40 so as to be movable in the X axis direction may be a member that rotates together with the transmission member 22, or may be a member that rotatably supports the transmission member 22 without rotating. The rotation about the shaft member in the present invention is a concept including both a configuration in which the shaft member (guide shaft) itself rotates together with the transmission member 22, the carriage 40, and the like and a configuration in which the transmission member 22, the carriage 40, and the like rotate without rotating the shaft member (guide shaft).

What is claimed is:

1. A medium processing device comprising:
a medium conveying mechanism that conveys a sheet-like medium in a medium feeding direction; and
a processing unit drive mechanism that includes a support unit that supports a processing unit that processes the medium, the processing unit drive mechanism being capable of executing a first operation of moving the support unit together with the processing unit along the medium in a support unit feeding direction intersecting the medium feeding direction, and a second operation of changing a distance between the medium and the processing unit by rotating the support unit together with the processing unit about a virtual axis along the support unit feeding direction.

2. The medium processing device according to claim 1, wherein
the processing unit drive mechanism includes a shaft member that guides the support unit movably in the support unit feeding direction about a virtual axis along the support unit feeding direction, and executes the second operation by rotating the support unit about the shaft member.

3. The medium processing device according to claim 2, wherein
the processing unit drive mechanism includes a transmission member that extends in the support unit feeding direction and rotates about the shaft member by transmitting power by a motor, and
the support unit moves in the support unit feeding direction along the shaft member and the transmission member in the first operation, and rotates together with the transmission member in the second operation.

4. The medium processing device according to claim 3, wherein
the transmission member includes a planar portion located on a plane including a central axis of the shaft member,
the support unit includes a contact portion that comes into contact with the planar portion, and
the processing unit drive mechanism brings the processing unit close to the medium by pressing the planar portion against the contact portion in the second operation.

5. The medium processing device according to claim 4, wherein
the transmission member includes the planar portion, a parallel planar portion substantially parallel to the planar portion, and a connection planar portion connecting the planar portion and the parallel planar portion, and
the contact portion is in contact with a vicinity of a corner portion of the planar portion connected to the parallel planar portion.

6. The medium processing device according to claim 3, further comprising:
a pair of connection members connecting the shaft member and the transmission member at both ends in the support unit feeding direction, wherein
the shaft member and the transmission member rotate together in the second operation.

7. The medium processing device according to claim 1, wherein
the processing unit is a cutting tool that cuts the medium, and
the support unit includes a holder detachable portion to and from which a holder for holding the cutting tool is attachable and detachable.

8. The medium processing device according to claim 1, wherein
the support unit includes a sensor that is capable of detecting an alignment mark provided on the medium.
